(19) United States
(12) Patent Application Publication
(10) Pub. No.: US 2021/0142949 A1
(43) Pub. Date: May 13, 2021

(54) ENERGY STORAGE SYSTEM, USE OF AN ENERGY STORAGE SYSTEM, CHARGING DEVICE, SYSTEM AND METHOD FOR CHARGING AN ENERGY STORE

(71) Applicant: Robert Bosch GmbH, Stuttgart (DE)

(72) Inventor: Yvan Gauthier, Kornwestheim (DE)

(21) Appl. No.: 16/492,278

(22) PCT Filed: Feb. 21, 2018
(86) PCT No.: PCT/EP2018/054252

§ 371 Date: Sep. 9, 2019

(30) Foreign Application Priority Data
Mar. 8, 2017 (DE) 10 2017 203 813.6

(51) Int. Cl. H01G 4/32; H01M 10/0587; H01M 10/44; H02J 7/00; B60K 1/04; B60L 50/40; B60L 50/60; B60L 53/37; B60L 53/50

(52) U.S. Cl. CPC H01G 4/32; H01M 10/0587; H01M 10/44; H02J 7/0047; B60K 1/04; H01G 4/14; B60L 50/60; B60L 53/37; B60L 53/50; H01M 2220/20; B60L 50/40

(57) ABSTRACT

The invention relates to an energy storage system, the use of an energy storage system, a charging device, a system and a method for charging an energy store, the system comprising a re-chargeable energy store (1) and said energy store (1) having a rotatably mounted first roll (2) and a film (4) having electrodes (60, 61, 63, 65, 66). The film (4) is at least partially wound on the first roll (2).

### BACKGROUND OF THE INVENTION

The present invention relates to an energy storage system, a use of an energy storage system, a charging device, a system and a method for charging an energy store.

US 2009/0268368 describes a rolled film capacitor. The film capacitor comprises two dielectric films, each of which is coated with a metallic electrode film.

Rechargeable energy stores, for example capacitors and/or battery systems, are employed in stationary applications, such as wind power installations or solar energy systems, and in motor vehicles, such as hybrid vehicles or electric vehicles, or in electronic devices such as laptop computers or mobile telephones.

### SUMMARY OF THE INVENTION

The invention proceeds from an energy storage system comprising a rechargeable energy store.

The core of the invention is provided in that the energy store comprises a rotatably mounted first roll and a film having electrodes, wherein the film is at least partially wound on the first roll.

The background to the invention is the unwinding and subsequent rewinding of the wound electrodes of the energy store. Accordingly, the electrodes, specifically for the purposes of charging, can be engaged in full-surface contact with a charge transmission means and/or an electron source.

According to the invention, the charging time can be shortened, and charging losses can be reduced.

According to one advantageous configuration, the energy storage system comprises take-up means for the film, which is arranged with a clearance from the first roll. As a result, the film can be paid out from the first roll and received by the take-up means.

The take-up means preferably comprises a rotatably mounted second roll, which is connected to the film, wherein the film can be wound onto the second roll. For charging purposes, the film can thus be paid out from the first roll and wound onto the second roll.

It is further advantageous, if the take-up means comprises a rotary motor for the pay-out of the film from the first roll and the winding of the film onto the second roll. Advantageously, the unwinding of film from the first roll and the winding of film onto the second roll can be executed automatically.

The rotary motor is preferably arranged in the interior of the second roll. The energy storage system can thus be configured to a compact design.

It is further advantageous if the energy store comprises reset means, specifically a spring element, for the pay-out of film from the second roll and the winding of film onto the first roll. For the winding-on of the film, the first roll can thus be driven by the reset means, specifically in a purely mechanical manner.

It is further advantageous if the energy storage system comprises a third rotatably mounted roll, wherein the third rotatably mounted roll is chargeable with electrons, wherein the third roll, for the charging of the energy store, engages with at least one electrode which is arranged on the film, and specifically wherein the third roll is rolled onto the film. Advantageously, the third roll engages in full-surface contact with the electrode. An even charging distribution is thus achieved on the electrode. The charging time can be shortened, and charging losses reduced.

Preferably, the second roll and the third roll are rotatably mounted on a carrier, wherein the carrier is pivotably mounted about a pivoting axis, wherein the pivoting axis, the axis of rotation of the second roll and the axis of rotation of the third roll are arranged at a distance from one another, and are essentially oriented in parallel. Advantageously, the orientation of the carrier is dependent upon the direction of rotation of the second roll. The carrier, upon the winding of film onto the second roll, thus pivots into a first pivot angle position and, upon the unwinding of film from the second roll, pivots into a second pivot angle position.

It is moreover advantageous if a pivot angle range of the carrier is limited by means of a first limiting means and a second limiting means, wherein the third roll engages with the film, if the carrier engages with the first limiting means, and wherein the third roll is spaced apart from the film, if the carrier engages with the second limiting means. Advantageously, the carrier engages with the second limiting means in the first pivot angle position and/or the carrier engages with the first limiting means in the second pivot angle position. By means of the limiting means, defined pivot angle positions of the carrier can be set accordingly.

According to one advantageous configuration, the energy store is configured as a capacitor, wherein the film is configured as a dielectric. Advantageously, the film functions as both a carrier material for the electrodes and as a dielectric. The energy store can thus be configured to a compact design.

According to a further advantageous configuration of the invention, the energy store is configured as a rechargeable battery, wherein the film is configured as a solid electrolyte. Advantageously, the film functions as both a carrier material for the electrodes and as an electrolyte. The energy store can thus be configured to a compact design.

The core of the invention, in the application of an energy storage system of the type described above, or according to one of the claims relating to the energy storage system for a vehicle, is provided in that the energy storage system is at least partially arranged in a vehicle.

The background to the invention is the configuration of the energy store within the vehicle in a pay-out arrangement. The charging time can be reduced as a result, as full-surface contact with the electrodes of the energy store is possible.

It is further advantageous if an electron-permeable region is arranged in the vehicle, specifically wherein the energy storage system is arranged completely within the vehicle. As a result, an electron source can be arranged outside the vehicle. The electron-permeable region is permeable to the electron stream from the electron source, such that the energy store is chargeable by means of the electrons.

The electron-permeable region is preferably arranged in a vehicle floor of the vehicle. The electron source can thus be arranged below the vehicle.

According to a further advantageous configuration, the take-up means is arranged outside the vehicle, wherein the vehicle comprises an opening, wherein the film is at least partially fed through the opening and is connected to the second roll by a coupling means. Advantageously, the second roll can be arranged outside the vehicle. The rotary motor of the second roll can thus be driven by a stationary voltage source.

The core of the invention, in the charging device for an energy storage system, specifically as described above or according to one of the claims relating to the energy storage system, is provided in that the charging device comprises an electron source, from which electrons are transmittable to at least one electrode of the energy storage system.

The electron source is preferably configured as a cathode-ray tube. Advantageously, this permits the employment of a high-energy electron stream for the charging of the energy store. The charging time can thus be shortened. The electrons are transmittable in a contactless arrangement.

According to an advantageous configuration, the charging device, for the positioning of the charging device relative to the energy storage system, is arranged in a moveable part, specifically wherein the charging device comprises at least one sensor for the determination of position. Accordingly, the positioning of the charging device relative to the energy storage system can be executed automatically.

The core of the invention, in the system for charging an energy store, is provided in that the system comprises an energy storage system, as described above or according to one of the claims relating to the energy storage system, and a charging device, as described above or according to one of the claims relating to the charging device.

The background to the invention is the pay-out of the electrodes of the energy store, for the purposes of charging, and the full-surface contacting thereof. The charging time can be reduced as a result.

The core of the invention, in the method for charging an energy store, specifically an energy storage system as described above or according to one of the claims relating to the energy storage system, is provided in that, in a first process step, a film of the energy store having at least one electrode is paid out and wherein, in a second process step, the film is rewound, such that the at least one electrode receives electrons.

The background to the invention is the full-surface contacting of the electrode of the energy store, in order to achieve an even distribution of electrons on the electrode. The charging time can be advantageously shortened as a result.

Preferably, in the second process step, a third roll, which carries electrons, rolls onto the film, and surrenders electrons to the at least one electrode. Advantageously, the electrode is charged by the resulting triboelectric effect. Preferably, the third roll has a lower affinity for electrons than the electrode which is arranged on the film.

It is further advantageous if an electron source generates electrons for the charging of the energy store, specifically wherein the electron source charges the third roll with electrons. Advantageously, the third roll is charged by means of an electron stream from the electron source in a contactless arrangement.

### BRIEF DESCRIPTION OF THE DRAWINGS

In the following section, the invention is described with reference to exemplary embodiments, from which further inventive characteristics can proceed, but which do not limit the scope of the invention. The exemplary embodiments are represented in the drawings.

In the drawings:

FIG. 1 shows a schematic representation of an energy storage system according to the invention in a first process step of a method according to the invention for the charging of an energy store;

FIG. 2 shows a schematic representation of a system according to the invention for charging an electric store in a second process step of the method according to the invention for charging an energy store;

FIG. 3 shows a detailed view of an electron source 20 and a third roll 7 of the system according to the invention for charging an energy store, in a side view;

FIG. 4 shows a vehicle 30 with a first exemplary embodiment of the system according to the invention for charging an energy store;

FIG. 5 shows a vehicle 30 with a second exemplary embodiment of the system according to the invention for charging an energy store;

FIG. 6a shows a detailed view of a film 4 of an energy store 1; and

FIG. 6b shows a side view of the film 4 of the energy store 1.

### DETAILED DESCRIPTION

FIG. 1 represents an energy store 1, having a first rotatably mounted roll 2 and a film 4, take-up means 12 having a second rotatably mounted roll 11, and a third rotatably mounted roll 7 of the energy storage system according to the invention.

The film 4 is configured as a dielectric of a capacitor or as a solid electrolyte of a battery, for example in the form of a plastic film. The film 4 is bonded to at least one electrode (60, 61, 63, 65, 66), specifically by coating.

A first end section of the film 4 is connected to the first roll 2, and is at least partially wound on the first roll 2. A second end section of the film 4 is connected to the second roll 11, and is at least partially wound on the second roll 11. The film 4 thus connects the first roll 2 to the second roll 11. The first roll 2 and the second roll 11 are thus arranged at a distance from one another.

The second roll 11 and the third roll 7 are arranged on two opposing end regions of a pivotable carrier 8, and are respectively rotatably mounted on the latter. The pivoting axis 10 of the carrier 8 is arranged between the axis of rotation 14 of the second roll 11 and the axis of rotation 6 of the third roll 7. The pivot angle range of the carrier 8 is limited by means of a first limiting means 5 and a second limiting means 9.

The axes of rotation (3, 6, 14) of the rolls (2, 7, 11) and the pivoting axis 10 of the carrier 8 are respectively arranged in parallel and at a distance from one another. The first roll 2 and the second roll 11 rotate in the same direction.

In the interior of the rotatably mounted first roll 2, a reset means 15, specifically a spring element, is arranged, which exerts a reset force on the first roll 2, such that the first roll 2, once the film 4 has been at least partially paid out, takes up the latter once more.

In the interior of the rotatably mounted second roll 11, a rotary motor 13, specifically a rotary electric motor is arranged, by means of which the second roll 11 is rotatable. As a result, the film 4 can be paid out from the first roll 2 and wound onto the second roll 11, specifically against the reset force of the reset means 15. The take-up means 12 for the film 4 comprises the second roll 11 and the rotary motor 13.

In a first process step of the method according to the invention for charging an energy store, the film is paid out from the first roll 2 by means of the rotary motor 13, and wound onto the second roll 11. The carrier 8 is pivoted through a first pivot angle, specifically until the carrier 8 engages with the second limiting means 9, such that the third roll 7 is spaced apart from the film 4. The first process step is complete when the film 4, at least partially, and specifically completely, is paid out from the first roll 2.

FIG. 2 represents a system for charging an energy store in a second process step.

The system for charging an energy store comprises the energy store 1, the second roll 11, the third roll 7, the carrier 8, the first limiting means 5 and the second limiting means 9, and a charging device comprising at least one electron source 20, specifically a cathode ray tube. The arrangement of the electron source 20 is configured such that an electron stream 21 emitted from the electron source 20 in the second process step strikes the third roll 7.

In the second process step, the second roll 11 is uncoupled from the rotary motor 13. As a result of the reset force of the spring element 15, the film 4 is paid out from the second roll 11 and wound onto the first roll 2. In the second process step, the direction of rotation of the first and second rolls (2, 11) is thus inverted, in relation to the first process step.

The carrier 8 is pivoted, in an opposite direction of pivoting to the direction of pivoting in the first process step, through a second pivot angle, until the carrier 8 engages with the first limiting means 5. As a result, the third roll 7 is pivoted such that the third roll 7 engages with the film 4 and/or with at least one of the electrodes (60, 61, 63, 65, 66) arranged on the film 4. The third roll 7 consequently rolls onto the film 4, after the film 4 has been paid out from the second roll 11 and before the film 4 has been wound onto the first roll 2. The third roll 7 is thus at least partially arranged between the first roll 2 and the second roll 11. The third roll 7 and the second roll 11 rotate in opposing directions.

At least one electrode (60, 61, 63, 65, 66) is arranged on the side of the foil 4 which faces the third roll 7, such that the electrode (60, 61, 63, 65, 66) engages with the third roll 7 in the second process step.

Preferably, the third roll 7 has a lower affinity for electrons than the electrode which is arranged on the film 4, for example, the third roll is configured of glass or acrylic glass, and the electrode is configured as a metallic coating of the film 4.

In the second process step, electrons are transferred from the electron source 20 to the third roll 7. These electrons are surrendered by the third roll 7 to the electrode which is arranged on the film 4, as the third roll 7 rolls onto the film 4.

FIG. 3 shows a side view of the electron source 20 and the third roll 7. The third roll 7 is rotatably mounted on the carrier 8, wherein the carrier 8 preferably comprises a fork, between the prongs of which the third roll 7 is arranged. The electron stream 21 from the electron source 20 is fanned out from the electron source 20 such that it irradiates the third roll 7 along the long side thereof, specifically over the full height of the third roll 7. Preferably, the electron stream 21 is fanned out in a triangular configuration.

FIG. 4 represents a first form of embodiment of the system according to the invention for charging an energy store in a vehicle 30.

In the vehicle 30, the energy store 1 with the film 4, the take-up means 12, the third roll 7 and the carrier 8 are arranged, specifically below at least one seat of the vehicle 30. A floor panel of the vehicle 30 incorporates an electron-permeable section, specifically an opening.

The vehicle 30 is arranged to travel on a carriageway 32. The carriageway 32 comprises an electron-permeable section 31, specifically an opening, below which the electron source 20 is arranged.

For the purposes of charging, the vehicle 30 is positioned above the electron source 20, such that the electron stream 21 emitted by the electron source 20 passes through the electron-permeable section 31 of the carriageway 32 and the electron-permeable section of the vehicle 30, strikes the third roll 7 and irradiates the latter.

FIG. 5 represents a second form of embodiment of the system according to the invention for charging an energy store in a vehicle 30.

The vehicle 30 is arranged to travel on a carriageway 42. The carriageway 42 comprises at least one opening 41.

The energy store 1, with the first roll, is arranged in the vehicle 30. The take-up means 12, the third roll 7, the carrier 8 and the electron source 20 are arranged in a moveable part 48 below the carriageway 42. The moveable part 48 is arranged to travel below the carriageway 42. Preferably, the moveable part 48 is arranged to travel by means of wheels (46, 47) running on rails 45.

The moveable part 48 comprises a sensor 49 for position detection. By means of the sensor 49, the position of the moveable part 48 relative to the vehicle 30 or relative to the energy store 1 can be determined. Accordingly, the position of the moveable part 48 can be adjusted to the position of the vehicle 30 or the position of the energy store 1.

The film 4 extends through an opening in a vehicle floor of the vehicle 30, and is connected by means of coupling means 43 to a further film 44, which is connected to the take-up means 12, specifically of the second roll 11. To this end, the film 4 and/or the further film 44 are routed through the cut-out 41 in the carriageway 42.

For the purposes of charging, the vehicle 30 is parked above the moveable part 48. The moveable part 48 is positioned below the vehicle 30 such that the film 4 and/or the further film 44 can be routed through the opening 41 in the carriageway, and the film 4 and the further film 44 are mutually connectable by means of the coupling means 43.

Preferably, the opening 41 in the carriageway 42 extends along a direction of travel of the moveable part 48, wherein the opening 41 specifically extends longitudinally. Alternatively, the carriageway 42 comprises a plurality of openings, which are arranged along the direction of travel of the moveable part 48.

In a further unrepresented exemplary embodiment, the energy storage system is arranged in the vehicle 30, and only the electron source 20 is arranged in a travelling moveable part below the carriageway. Preferably, the moveable part is arranged to travel by means of wheels running on rails.

The moveable part comprises a sensor for position detection. By means of the sensor, the position of the moveable part relative to the vehicle 30 or relative to the energy store 1 can be determined. Accordingly, the position of the moveable part can be adjusted to the position of the vehicle 30 or the position of the energy store 1.

The vehicle floor of the vehicle 30 comprises an electron-permeable section, specifically an opening. The carriageway comprises an electron-permeable section, specifically an opening.

Preferably, the electron-permeable section in the carriageway extends along a direction of travel of the moveable part, wherein the electron-permeable section specifically extends longitudinally. Alternatively, the carriageway comprises a plurality of electron-permeable sections, which are arranged along the direction of travel of the moveable part.

For the purposes of charging, the vehicle 30 is parked above the moveable part. The moveable part is positioned below the vehicle, such that the electron stream 21 from the electron source passes through the electron-permeable section in the carriageway and the electron-permeable section of the vehicle 30, and strikes the third roll 7.

FIGS. 6a and 6b show a detailed representation of the film 4 with the electrodes (60, 61, 63, 65, 66). On each side of the film 4, at least one electrode (60, 61, 63, 65, 66) is arranged. Accordingly, electrodes (63, 65, 66) of the cathode are arranged on one side of the film 4, and electrodes (60, 61) of the anode are arranged on the opposing side of the film 4. In FIG. 6a, the electrodes (60, 61) of the anode are represented by broken lines, as these are located on the side of the film 4 which is averted from the viewer.

The electrodes (63, 65, 66) of the cathode and the electrodes (60, 61) of the anode are arranged in an alternating manner in a direction of extension of the film 4, specifically in a winding direction, in which the film 4 is wound onto the first roll 2. The film 4, both in the direction of extension and in a transverse direction to the direction of extension, is thus arranged between a respective electrode (63, 65, 66) of the cathode and a respective electrode (60, 61) of the anode which is closest to said electrode (63, 65, 66).

Preferably, each electrode (60, 61, 63, 65, 66) extends in the winding direction onto the film 4 such that, in the wound-on state thereof on the first roll 2, essentially at least one turn around the first roll 2 is formed. The width of the electrodes (60, 61, 63, 65, 66) thus increases in the winding direction, in accordance with the increasing diameter of the film winding on the first roll 2.

In the direction of extension of the film 4, a respective electrode-free film section 64 is thus arranged between the electrodes (60, 61, 63, 65, 66).

The electrodes (63, 65, 66) of the cathode are arranged flush to the left of the film 4, and the electrodes (60, 61) of the anode are arranged flush to the right of the film 4. The electrodes (60, 61, 63, 65, 66) thus extend in a transverse direction to the winding direction on one side, up to the edge of the film 4 and, on the opposing side, are spaced apart from the edge of the film 4. As a result, the electrodes (60, 61, 63, 65, 66) of the cathode or anode are laterally contactable.

The film 4 comprises a first protective film section 62 and a second protective film section 67, which are respectively arranged on a respective end region of the film 4. By means of the first protective film section 62, the film 4 is connected to the second roll 11. By means of the second protective film section 67, the film 4 is connected to the first roll 2. The respective protective film section (62, 67) is at least configured to a sufficient width, such that the respective roll can accommodate at least one turn of the respective protective film section (62, 67).

In a further unrepresented exemplary embodiment, the film comprises two film layers which are mutually connected, specifically by adhesive bonding or welding. On a first film layer, at least one electrode of the anode is arranged on one side and, on a second film layer, at least one electrode of the cathode is arranged on one side. The film layers are mutually connected, such that film is arranged between the electrodes of the anode and the cathode in each case.

1. An energy storage system comprising a rechargeable energy store (1), characterized in that the energy store (1) comprises a rotatably mounted first roll (2) and a film (4) having electrodes (60, 61, 63, 65, 66), wherein the film (4) is at least partially wound on the first roll (2).

2. The energy storage system as claimed in claim 1, characterized in that the energy storage system comprises take-up means (12) for the film (4), which is arranged with a clearance from the first roll (2).

3. The energy storage system as claimed in claim 2, characterized in that the take-up means (12) comprises a rotatably mounted second roll (11), which is connected to the film (4), and which is configured such that the film (4) can be wound onto the second roll (11).

4. The energy storage system as claimed in claim 2, characterized in that the take-up means (12) comprises a rotary motor (13) for pay-out of the film (4) from the first roll (2) and winding of the film (4) onto the second roll (11).

5. The energy storage system as claimed in claim 2, characterized in that the energy store (1) comprises reset means (15) for pay-out of the film (4) from the second roll (11) and winding of the film (4) onto the first roll (2).

6. The energy storage system as claimed in claim 3, characterized in that the energy storage system comprises a third rotatably mounted roll (7), wherein the third rotatably mounted roll (7) is chargeable with electrons, wherein the third roll (7), for charging of the energy store (1), engages with at least one electrode (60, 61, 63, 65, 66) which is arranged on the film (4).

7. The energy storage system as claimed in claim 6, characterized in that the second roll (11) and the third roll (7) are rotatably mounted on a carrier (8), wherein the carrier (8) is pivotably mounted about a pivoting axis (10), wherein the pivoting axis (10), an axis of rotation (14) of the second roll (11) and an axis of rotation (6) of the third roll (7) are arranged at a distance from one another, and are substantially parallel.

8. The energy storage system as claimed in claim 7, characterized in that a pivot angle range of the carrier (8) is limited by a first limiting means (5) and a second limiting means (9), wherein the third roll (7) engages with the film (4), if the carrier (8) engages with the first limiting means (5), and wherein the third roll (7) is spaced apart from the film (4), if the carrier (8) engages with the second limiting means (9).

9. The energy storage system as claimed in claim 1, characterized in that the energy store (1) is configured as a capacitor, wherein the film (4) is configured as a dielectric.

10. The energy storage system as claimed in claim 1, characterized in that the energy store (1) is configured as a rechargeable battery, wherein the film (4) is configured as a solid electrolyte.

11. A vehicle comprising an energy storage system as claimed in claim 1, wherein the energy storage system is at least partially arranged in the vehicle (30).

12. The vehicle as claimed in claim 11, characterized in that an electron-permeable region is arranged in the vehicle (30), specifically in a vehicle floor of the vehicle (30), specifically wherein the energy storage system is arranged in the vehicle (30).

13. The vehicle as claimed in claim 11, wherein the energy storage system comprises take-up means (12) for the film (4), which is arranged with a clearance from the first roll (2), and wherein the take-up means (12) is arranged outside the vehicle (30), wherein the vehicle (30) comprises an opening, wherein the film (4) is at least partially fed through the opening and is connected to a second roll (11) by a coupling means (43), the second roll being rotatably mounted and configured such that the film (4) can be wound onto the second roll (11).

14. A charging device for an energy storage system as claimed in claim 1, characterized in that the charging device comprises an electron source (20), specifically a cathode ray tube, from which electrons are transmittable to at least one electrode (60, 61, 63, 65, 66) of the energy storage system (1).

15. The charging device as claimed in claim 14, characterized in that the charging device, for positioning of the charging device relative to the energy storage system, is arranged in a moveable part (48), specifically wherein the charging device comprises at least one sensor (49) for the determination of position.

16. A system for charging an energy store (1), characterized in that the system comprises an energy storage system as claimed in claim 1, and a charging device comprising an electron source (20) from which electrons are transmittable to at least one electrode (60, 61, 63, 65, 66) of the energy storage system (1).

17. A method for charging an energy store (1), specifically an energy storage system as claimed in claim 1, characterized in that in a first process step, a film (4) of the energy store (1) having at least one electrode (60, 61, 63, 65, 66) is paid out and wherein, in a second process step, the film (4) is rewound, such that the at least one electrode (60, 61, 63, 65, 66) receives electrons.

18. The method as claimed in claim 17, characterized in that in the second process step, a third roll (7), which carries electrons, rolls onto the film (4), and surrenders electrons to the at least one electrode (60, 61, 63, 65, 66).

19. The method as claimed in claim 17, characterized in that an electron source (20) generates electrons for the charging of the energy store (1), specifically wherein the electron source (20) charges the third roll (7) with electrons.

20. The energy storage system as claimed in claim 2, characterized in that the take-up means (12) comprises a rotary motor (13) for pay-out of the film (4) from the first roll (2) and winding of the film (4) onto the second roll (11), wherein the rotary motor (13) is arranged in an interior of the second roll (11).

21. The energy storage system as claimed in claim 2, characterized in that the energy store (1) comprises reset means including a spring element for pay-out of the film (4) from the second roll (11) and winding of the film (4) onto the first roll (2).

22. The energy storage system as claimed in claim 3, characterized in that the energy storage system comprises a third rotatably mounted roll (7), wherein the third rotatably mounted roll (7) is chargeable with electrons, wherein the third roll (7), for charging of the energy store (1), engages with at least one electrode (60, 61, 63, 65, 66) which is arranged on the film (4), and wherein the third roll (7) is rolled onto the film (4).
